(19) United States
(12) Patent Application Publication
(10) Pub. No.: US 2002/0065209 A1
(43) Pub. Date: May 30, 2002

(54) Surfactant system used to improve processing of gel air fresheners

(76) Inventors: Robert J. Valesky, Hatboro, PA (US); Stephen F. Gross, Souderton, PA (US); Timothy C. Morris, Morton, PA (US)

Correspondence Address: COGNIS CORPORATION, 2500 RENAISSANCE BLVD., SUITE 200, GULPH MILLS, PA, 19406

(21) Appl. No.: 09/950,969

(22) Filed: Sep. 12, 2001

Related U.S. Application Data
(60) Provisional application No. 60/238,970, filed on Oct. 10, 2000.

(51) Int. Cl. C09K 3/00

(52) U.S. Cl. 512/4; 512/1; 516/98; 516/902

(57) ABSTRACT

4:21 PM 3/6/02 A gel-form air freshener composition containing: (a) a linear alcohol alkoxylate in an amount of not more than about 7% by weight; (b) an amine oxide in an amount of not more than about 10% by weight; (c) a fragrance component in an amount of not more than about 10% by weight; and (d) an aqueous gel base in an amount of not more than about 96% by weight, all weights being based on the total weight of the gel-form air freshener composition.

### CROSS-REFERENCE TO RELATED APPLICATIONS

This application claims the benefit of copending provisional application serial No. 60/238,970 filed on Oct. 10, 2000.

### STATEMENT REGARDING FEDERALLY SPONSORED RESEARCH OR DEVELOPMENT

Not applicable.

### BACKGROUND OF THE INVENTION

Transparent gel air fresheners, currently on the market, generally contain an aqueous gel base, a fragrance component, a nonionic surfactant (typically a linear alcohol ethoxylate (LAE), and a co-solvent. Processing of the gel to make the air freshener involves heating the aqueous gel to a temperature of approximately 77° C. However, at this temperature, and under these conditions, a uniform emulsion is not formed when using LAE as the nonionic surfactant. At this temperature, the cloud point of the LAE is surpassed and the fragrance component tends to come out of solution.

Furthermore, a significant amount of nonionic surfactant, i.e., approximately 13%/wt. active surfactant, is needed in order to maintain a robust system capable of solubilizing several different types of fragrances. It has surprisingly been found that the use of a specific type of mixed surfactant system can alleviate some of these processing problems, while at the same time maintaining the benefits of the final product.

### BRIEF SUMMARY OF THE INVENTION

The present invention is directed to a gel-form air freshener containing:

(a) a linear alcohol alkoxylate in an amount of not more than about 7% by weight;

(b) an amine oxide in an amount of not more than about 10% by weight;

(c) a fragrance component in an amount of not more than about 10% by weight; and

(d) an aqueous gel base in an amount of not more than about 96% by weight, all weights being based on the total weight of the gel-form air freshener.

The present invention is also directed to a process for making a gel-form air freshener involving the steps of:

(a) providing an aqueous gel base;

(b) providing a linear alcohol alkoxylate;

(c) providing an amine oxide;

(d) providing a fragrance component;

(e) combining the linear alcohol ethoxylate, amine oxide and fragrance component to form a surfactant pre-mix; and

(f) combining the aqueous gel base and the surfactant pre-mix, at a temperature of from about 75 to about 80° C., to form the gel-form air freshener.

### BRIEF DESCRIPTION OF THE SEVERAL VIEWS OF THE DRAWINGS

Not applicable.

### DETAILED DESCRIPTION OF THE INVENTION

Other than in the operating examples, or where otherwise indicated, all numbers expressing quantities of ingredients and reaction conditions are understood as being modified, in all instances, by the term “about”.

The aqueous gel base component used to make the air freshener generally consists of water and gellan gum, as defined in CAS # 71010-52-1, the entire contents of which is hereby incorporated by reference. Such gellan gums are commercially available from Kelco Biopolymers division of Monsanto Corp. under the tradename KELCOGEL® AFT. The aqueous gel base component is present in the gel-form air freshener in an amount of not more than about, with increasing preference in the order given, 96%; 90%; 85%; 80%; or 75% by weight and, independently, in an amount of not less than about, with increasing preference in the order given, 55%; 59%; 63%; 67%; or 71% by weight, all weights based on the total weight of the gel-form air freshener.

The surfactant blend of the present invention contains a mixture of a linear alcohol alkoxylate and an amine oxide. Suitable linear alcohol alkoxylates for use in the present invention include those derived from linear alcohols wherein the number of carbon atoms in the molecule preferably is at least about, with increasing preference in the order given, 8, 9, 10, 11, or 12, and independently preferably is not more than about, with increasing preference in the order given, 19, 18, 17, 16, or 15. These linear alcohols are in turn alkoxylated with preferably up to about, with increasing preference in the order given, 8, 9, 10, 11, or 12 moles of ethylene oxide, and/or up to about, with increasing preference in the order given, 4, 3, 2, 1, or 0 moles of propylene oxide. In a particularly preferred embodiment, the linear alcohol alkoxylate of the present invention is a C₁₂₋₁₅ alcohol having 12 moles of ethylene oxide commercially available from Tomah Corp. under the tradename TOMADOL® 25-12.

The linear alcohol ethoxylate is present in the gel-form air freshener in an amount of not more than about, with increasing preference in the order given, 7; 6; 5; 4; or 3% by weight, based on the total weight of the gel-form air freshener, and independently in an amount of at least about, with increasing preference in the order given, 0.5; 1; 1.5; 2; or 2.5% by weight, based on the total weight of the gel-form air freshener.

Amine oxides which may be used in the present invention are those which correspond to formula I:

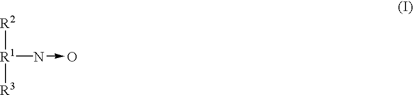

wherein R¹ is an alkyl or alkenyl radical having from about 7 to about 18 carbon atoms, and R² and R³ are, individually, alkyl or hydroxyalkyl radicals having from about 1 to about 4 carbon atoms. Examples of amine oxides which may be used in the present invention include, but are not limited to, lauryl amine oxide, cocamine oxide, cocamidopropyl amine oxide, lauryl amido propyl amine oxide. A particularly preferred amine oxide is cocamidopropyl amine oxide, commercially available from Cognis Corporation under the tradename STANDAMOX® CAW (35% active).

The amine oxide is present in the gel-form air freshener in an amount of not more than about, with increasing preference in the order given, 10; 9; 8; 7; or 6% by weight active, based on the total weight of the gel-form air freshener, and independently in an amount of at least about, with increasing preference in the order given, 0.5; 1; 2; 3; or 4% by weight active, based on the total weight of the gel-form air freshener.

Suitable fragrance components are those which are conventionally used in air fresheners. Examples thereof include, but are not limited to, citrus and jasmine fragrance. The fragrance component is present in the gel-form air freshener in an amount of not more than about, with increasing preference in the order given, 10; 9; 8; 7; or 6% by weight, based on the total weight of the gel-form air freshener, and independently in an amount of at least about, with increasing preference in the order given, 1; 2; 3; 4; or 5% by weight, based on the total weight of the gel-form air freshener.

As a result of the specific types of surfactants employed in the air freshener composition, a co-solvent such as ethanol, for example, need not be employed in the air freshener composition.

According to yet another embodiment of the present invention, there is provided a process for making a gel-form air freshener composition. First, the aqueous gel base component is heated, with stirring, to a temperature of not more than about, with increasing preference in the order given, 88; 86; 84; 82; or 80° C., and independently to a temperature of not less than about, with increasing preference in the order given, 75; 77; 79; 81; or 83° C., until a uniform solution is obtained. In a particularly preferred embodiment, the gel base component is heated to a temperature of about 83° C.

Next, in a separate container, the linear alcohol ethoxylate, amine oxide and fragrance component are combined, with stirring, to form the surfactant pre-mix. The gel base component is allowed to cool to a temperature of not more than about, with increasing preference in the order given, 81; 80; 79; 78; or 77° C., and independently to a temperature of not less than about, with increasing preference in the order given, 72; 73; 74; 75; or 76° C., at which time the surfactant pre-mix is added to the gel base component, with stirring, to form the gel-form air freshener composition.

In a particularly preferred embodiment, the gel base component is cooled to a temperature of about 77° C., prior to its being combined with the surfactant pre-mix.

The gel-form air freshener composition is then further cooled, with stirring to a temperature of not more than about, with increasing preference in the order given, 68; 66; 64; 62; or 60° C., and independently to a temperature of not less than about, with increasing preference in the order given, 50; 52; 54; 56; or 58° C. In a particularly preferred embodiment, the gel-form air freshener composition is cooled, with mixing, to a temperature of about 60° C.

The gel-form air freshener composition may then be poured into a mold or cast and cooled to room temperature to form a clear solid gel-form air freshener.

The present invention will be better understood from the examples which follow, all of which are intended for illustrative purposes only, and are not meant to unduly limit the scope of the invention in any way.

### EXAMPLES

A commercial gel-form air freshener, used for comparison purposes, was prepared using the following formula and methodology:

| Ingredient | % wt. |
|---|---|
| KELCOGEL ® Base | 81.93 |
| TOMADOL ® 25-12 | 13.00 |
| Romantic Jasmine | 5.00 |
| KATHON ® CG/ICP | 0.07 |

1—KELCOGEL® Base=water 98.5%, sodium citrate 0.5%, Kelcogel AFT 1.0%

2—TOMADOL® 25-12=C₁₂₋₁₅ linear alcohol having 12 moles of ethylene oxide.

| 1-KELCOGEL ® Base = | water 98.5%, solium citrate 0.5%, | |
|---|---|---|
| | Kelcogel AFT 1.0% | |
| 2-TOMADOL ® 25-12 = | C₁₂₋₁₅ linear alcohol having | |
| | 12 moles of ethylene oxide. | |
| 3-KATHON ® CG/ICP = | 5-chloro-2-methyl-4-isothiazolin-3- | 1.11% |
| | one | |
| | 2-methyl-4-isothiazolin-3-one | 0.39% |
| | inert ingredients | 98.5% |
| | | 100.0% |

KELCOGEL® Base was heated to approximately 83° C. with stirring on a lab mixer until solution was uniform. TOMADOL® 25-12 and Romantic Jasmine were mixed in a separate container until uniform to form a surfactant pre-mix. The KELCOGEL® Base was then cooled to a temperature of approximately 77° C. at which time the surfactant/perfume pre-mix was added, with stirring to form the gel-form air freshener composition. The gel-form air freshener composition was then cooled, with continuous mixing to a temperature of approximately 60° C., after which it was poured into a container and allowed to cool to room temperature.

It was observed that the cloud point of Tomadol 25-12, by itself, was too low under these conditions and, as a result, the fragrance component had a tendency of coming out of solution at temperatures slightly elevated above room temperature.

Another gel-form air freshener was prepared using the same procedure as the comparison example, but employing a formulation in accordance with the present invention:

| Ingredient | % wt. |
|---|---|
| KELCOGEL ® Base | 78.96 |
| TOMADOL ® 25-12 | 2.43 |
| STANDAMOX ® CAW (35% | 13.54 |
| active) | |
| Romantic Jasmine | 5.00 |
| KATHON ® CG/ICP | 0.07 |

The TOMADOL® 25-12/STANDAMOX® CAW surfactant system was found to completely solubilize the fragrance component. The surfactant/perfume pre-mix was clear after addition to the molten KELCOGEL Base at 170° F. The cloud point of the pre-mix was much higher than the processing temperature as a result of the addition of the amine oxide. The Romantic Jasmine/surfactant pre-mix was hazy by itself, but upon addition to the KELCOGEL Base yielded a clear solution. A stiff, clear gel was made when the gel-form air freshener composition was cooled to room temperature. No syneresis was observed in the sample at room temperature or after one freeze/thaw cycle.

In summary, the benefits of gel-form air freshener compositions of the present invention versus conventional compositions include:

less residue of the dried gel is observed due to less total surfactant being used, i.e., 13% wt. actives in the comparison example versus 6.5 % wt. actives;

the finished gels are crystal clear at room temperature;

the cloud point of the surfactant system is increased to >77° C. which is above the processing temperature, resulting in a clear, molten KELCOGEL Base being formed;

the molten gel base is not viscous at elevated temperatures;

the amine oxide surfactant does not interfere with the gelling process;

all available fragrances are effectively solubilized using the same surfactant system;

no syneresis is observed at room temperature or after one freeze/thaw cycle; and

no co-solvents such as ethanol are employed in the process.

What is claimed is:

1. A gel-form air freshener composition comprising:
(a) a linear alcohol alkoxylate in an amount of not more than about 7% by weight;
(b) an amine oxide in an amount of not more than about 10% by weight;
(c) a fragrance component in an amount of not more than about 10% by weight; and
(d) an aqueous gel base in an amount of not more than about 96% by weight, all weights being based on the total weight of the gel-form air freshener composition.

2. The composition of claim 1 wherein the linear alcohol alkoxylate is present in the composition in an amount of at least about 0.5% by weight, based on the weight of the composition.

3. The composition of claim 1 wherein the linear alcohol alkoxylate is a linear alcohol ethoxylate having up to about 12 moles of ethylene oxide.

4. The composition of claim 1 wherein the linear alcohol alkoxylate is a C₁₂₋₁₅ linear alcohol having up to about 12 moles of ethylene oxide.

5. The composition of claim 1 wherein the amine oxide is present in the composition in an amount of at least about 0.5% by weight, based on the weight of the composition.

6. The composition of claim 1 wherein the amine oxide is a cocamidopropyl amine oxide.

7. The composition of claim 1 wherein the fragrance component is present in the composition in an amount of at least about 1% by weight, based on the weight of the composition.

8. The composition of claim 1 wherein the aqueous gel base is present in the composition in an amount of at least about 55% by weight, based on the weight of the composition.

9. A process for making a gel-form air freshener composition comprising:
(a) providing an aqueous gel base;
(b) providing a linear alcohol alkoxylate;
(c) providing an amine oxide;
(d) providing a fragrance component;
(e) combining the linear alcohol ethoxylate, amine oxide and fragrance component to form a surfactant pre-mix; and
(f) combining the aqueous gel base and the surfactant pre-mix, at a temperature of not more than about 81° C., to form the gel-form air freshener.

10. The process of claim 9 wherein the aqueous gel base is employed in an amount of not more than about 96% by weight, based on the weight of the composition.

11. The process of claim 9 wherein linear alcohol alkoxylate is employed in an amount of not more than about 10% by weight, based on the weight of the composition.

12. The process of claim 9 wherein the amine oxide is employed in an amount of not more than about 10% by weight, based on the weight of the composition.

13. The process of claim 9 wherein the fragrance component is employed in an amount of not more than about 10% by weight, based on the weight of the composition.

14. The process of claim 9 wherein the linear alcohol alkoxylate is present in the composition in an amount of at least about 0.5% by weight, based on the weight of the composition.

15. The process of claim 9 wherein the linear alcohol alkoxylate is a linear alcohol ethoxylate having up to about 12 moles of ethylene oxide.

16. The process of claim 9 wherein the linear alcohol alkoxylate is a C₁₂₋₁₅ linear alcohol having up to about 12 moles of ethylene oxide.

17. The process of claim 9 wherein the amine oxide is present in the composition in an amount of at least about 0.5% by weight, based on the weight of the composition.

18. The process of claim 9 wherein the amine oxide is a cocamidopropyl amine oxide.

19. The process of claim 9 wherein the fragrance component is present in the composition in an amount of at least about 1% by weight, based on the weight of the composition.

20. The process of claim 9 wherein the aqueous gel base is present in the composition in an amount of at least about 55% by weight, based on the weight of the composition.

21. The process of claim 9 wherein the aqueous gel base is first heated to a temperature of not more than about 88° C. prior to its combination with the surfactant pre-mix.

22. The process of claim 9 wherein the aqueous gel base is first heated to a temperature of not less than about 75° C. prior to its combination with the surfactant pre-mix.

23. The process of claim 9 wherein step (f) is carried out at a temperature of not less than about 76° C.

24. The process of claim 9 further comprising cooling the aqueous gel-form composition to a temperature of not more than about 68° C. to form a cooled composition, and then pouring the cooled composition into a mold to form a solid, gel-form air freshener.
